(19) United States
(12) Patent Application Publication
(10) Pub. No.: US 2022/0099836 A1
(43) Pub. Date: Mar. 31, 2022

(54) METHOD FOR MEASURING DEPTH USING A TIME-OF-FLIGHT DEPTH SENSOR

(71) Applicants: Apical Limited, Cambridge (GB); Arm Limited, Cambridge (GB)

(72) Inventors: Daren CROXFORD, Swaffham Prior (GB); Roberto LOPEZ MENDEZ, Cambridge (GB); Viacheslav CHESNOKOV, Loughborough (GB); Maxim NOVIKOV, Loughborough (GB); Mina Ivanova DIMOVA, Great Shelford (GB)

(21) Appl. No.: 17/037,146

(22) Filed: Sep. 29, 2020

(51) Int. Cl. G01S 17/894; G01S 17/10; H04N 5/369

(52) U.S. Cl. CPC G01S 17/894; H04N 5/36965; G01S 17/10

(57) ABSTRACT

A method and apparatus for measuring depth using a time-of-flight (ToF) depth sensor is described. The apparatus includes an emitter configured to emit a signal towards a scene comprising one or more regions with light or sound, this emitter being controllable to adjust at least one of an intensity and a modulation frequency of the signal output from the emitter. The apparatus also includes a signal sensor, configured to detect an intensity of the signal from the emitter that has been reflected by the scene. A controller is configured to receive context information about the scene for depth capture by the time-of-flight depth sensor and to adjust at least one of the intensity and modulation frequency of the signal output by the emitter in dependence on the context information.

### BACKGROUND OF THE INVENTION

### Field of the Invention

The present invention relates to a method for measuring depth and a Time-of-Flight (ToF) depth sensor.

### Description of the Related Technology

Depth sensors have become increasingly prevalent in electronic devices. They see heavy use in automotive applications and the manufacturing industry, as well as in Augmented Reality systems and in security applications for mobile devices. Time-of-Flight (ToF) depth sensing technology is widely used in modern depth sensors.

Time-of-Flight sensors work by illuminating a scene with modulated light, typically infrared light, and measuring the light reflected from the scene in order to determine depth values within the scene. Although Time-of-Flight sensors typically make use of modulated light, Time-of-Flight sensors that work using other types of emission, such as ultrasound are in use as well. As Time-of-Flight depth sensors have developed, a desire for higher resolution has led to increased illumination intensities, increased modulation frequency of the illumination light, and increased frequency of measurement of reflected light. The increased measurement frequency and resolutions have in turn increased the data processing required to calculate the depth values. Accordingly, the illuminator and a processor within the Time-of-Flight sensor consume increasing amounts of power, especially when operating with higher light intensity and frequency of measurement. Such higher intensities and frequencies are necessary in certain applications (e.g. rapidly moving devices, distant objects, outdoor environments) and unnecessary in others (e.g. static devices, indoor environment). In some applications, such as employing depth sensors in a headset for extended reality (XR), augmented reality (AR) and mixed reality (MR) applications, the power available may be limited.

A method and apparatus to balance power consumption against required performance is therefore desirable.

### SUMMARY

According to a first aspect there is provided a time-of-flight (ToF) depth sensor apparatus, comprising an emitter configured to emit a signal towards a scene, which emitter is controllable to adjust at least one of an intensity and a modulation frequency of the signal output from the emitter; at least one signal sensor, configured to detect an intensity of the signal from the emitter that has been reflected by the scene; and a controller configured to receive context information about the scene for depth capture by the time-of-flight depth sensor and to adjust at least one of the intensity and modulation frequency of a signal output by the emitter in dependence on the context information.

According to a second aspect there is provided a method for measuring depth using a Time-of-Flight (ToF) depth sensor apparatus, the method comprising: receiving context information about a scene for depth capture by the time-of-flight depth sensor; adjusting, in dependence on the received context information, a modulation frequency or intensity of a signal to be output from at least one emitter; emitting a signal towards the scene using the at least one emitter with the adjusted intensity or modulation frequency of output signal; detecting, using at least one signal sensor, the intensity of light from the emitter that has been reflected by the scene; and calculating at least one depth measurement based on the measured intensity of the detected signal that has been reflected by the scene.

According to a third aspect there is provided a non-transitory computer readable storage medium comprising instructions that, when executed by a time-of-flight sensor apparatus, cause the time-of-flight sensor apparatus to perform a method comprising: receiving context information about a scene for depth capture by the time-of-flight depth sensor; adjusting, in dependence on the received context information, a modulation frequency or intensity of a signal to be output from at least one emitter; emitting a signal towards the scene using the at least one emitter with the adjusted intensity or modulation frequency of output signal; detecting, using at least one signal sensor, the intensity of signal from the emitter that has been reflected by the scene; and calculating at least one depth measurement based on the measured intensity of the detected signal that has been reflected by the scene.

### BRIEF DESCRIPTION OF THE DRAWINGS

Embodiments will now be described, by way of example only, with reference to the accompanying drawings in which:

FIG. 1A is a schematic diagram showing hardware of a ToF depth sensor suitable for use on an item of user equipment;

FIG. 1B is a schematic diagram showing a further implementation of a ToF depth sensor suitable for use on an item of user equipment;

FIG. 2 is a schematic diagram showing basic operation of a ToF depth sensor;

FIG. 3 is a flow chart showing steps of a method for measuring depth using a ToF depth sensor system;

FIG. 4 a flow chart showing steps of a method of a ToF depth sensor of the type described in connection with FIG. 1B;

FIG. 5A is a diagram showing an arrangement of illuminators of a ToF system;

FIG. 5B is a diagram depicting the illumination of a scene by a system utilizing the illuminator configuration of FIG. 5A;

FIG. 6A is a schematic diagram showing a tile-based illumination sensor;

FIG. 6B is a circuit diagram of a photodetector element for a ToF depth sensor system;

FIG. 6C is a timing diagram showing timings of the photodetector shown in FIG. 6B;

FIG. 7A is a diagram showing sensor readout schemes; and

FIG. 7B is a diagram showing a striped-tiled sensor readout scheme.

### DETAILED DESCRIPTION OF CERTAIN INVENTIVE EMBODIMENTS

Before discussing particular embodiments with reference to the accompanying figures, the following description of embodiments is provided.

In a first embodiment there is provided a time-of-flight (ToF) depth sensor apparatus comprising an emitter configured to emit a signal towards a scene, which emitter is controllable to adjust at least one of an intensity and a modulation frequency of the signal output from the emitter; at least one signal sensor, configured to detect an intensity of the signal from the emitter that has been reflected by the scene; and a controller configured to receive context information about the scene for depth capture by the time-of-flight depth sensor and to adjust at least one of the intensity and modulation frequency of a signal output by the emitter in dependence on the context information.

In some embodiments the signal may be light. In other embodiments, the signal may be sound waves.

In the context of this application, the term “light” is understood to encompass both visible and nonvisible electromagnetic radiation. In many embodiments this radiation will be in the infrared (IR) wavelength (700 nm to 1 mm). In many embodiments, the intensity of the radiation is controlled not exceed the bounds of the range permitted by appropriate safety regulations.

In some embodiments, the emitter may be configurable to capture images periodically at one of a plurality of refresh rates of the sensor. In such embodiments, the controller may be configured to control the refresh rate of the signal sensor in dependence upon the context information. The refresh rate of the signal sensor may be controlled to be different from that of the emitter.

In some embodiments, the emitter is a single emission source. Alternatively, the emitter may comprise a plurality of emission sources. The controller may be configured to control at least one of the intensity and modulation frequency of each emission source separately. These emission sources may be configured to direct signals to different portions of the scene presented for depth capture, or to not emit signals to one or more portions of the scene. In some embodiments the emitter may comprise a single emission source with a plurality of reflective elements arranged to direct the signal to different portions of the scene.

In some embodiments, the ToF depth sensor apparatus also comprises at least one context sensor. The context sensor may be at least one of: an accelerometer, an image-sensing component, and a location sensing component. In some embodiments, the controller is configured to receive a signal from the context sensor and to adjust at least one of the intensity and frequency of the signal output by the emitter in dependence upon the signal received from the context sensor. Where the context sensor is an accelerometer, the controller may be configured to control the illuminator to increase the modulation frequency in response to a detection of movement by the accelerometer. The ToF depth sensor apparatus, including the context sensor, may form part of a device such as a mobile telecommunications device or a headset device.

In some embodiments in which the context sensor is an image-sensing component, the context sensor may be configured to detect motion in the scene, and the controller may be configured to increase the modulation frequency in response to a detection of movement in the scene.

In some embodiments in which the context sensor is an image-sensing component, the ToF depth sensor apparatus may be configured to, in response to determining that a change between successive images captured by the image-sensing component is greater than a threshold value, perform the aforementioned steps of emitting a signal towards the scene, detecting the intensity of the signal that has been reflected by the scene, and determining at least one depth measurement.

In some embodiments, the at least one signal sensor may comprise multiple raster scan signal sensors configured to detect the signal from the emitter that has been reflected by the scene.

In other embodiments, the time-of-flight sensor apparatus may comprise a single signal sensor comprising a plurality of detectors, which plurality of detectors are grouped across the surface of the sensor into tiles of detectors. The time-of-flight sensor apparatus may be configured to read-out data from the signal sensor on a tile-by-tile basis. In such embodiments, the time-of-flight sensor may be configured to compress pixel values read out from the signal sensor on a tile-by-tile basis. The time-of-flight sensor may be configured to calculate depth values based on a plurality of tile readouts from the signal sensor, each readout occurring at a different time, wherein the calculation of depth values is performed on a tile-by-tile basis.

In a second embodiment there is provided a method for measuring depth using a Time-of-Flight (ToF) depth sensor, the method comprising: receiving context information about a scene for depth capture by the time-of-flight depth sensor; adjusting, in dependence on the received context information, a modulation frequency or intensity of a signal to be output from at least one emitter; emitting a signal towards the scene using the at least one emitter with the adjusted intensity or modulation frequency of output signal; detecting, using at least one sensor, the intensity of a signal from the emitter that has been reflected by the scene; and calculating at least one depth measurement based on the measured intensity of the detected signal that has been reflected by the scene.

The context information may comprise information regarding content of the scene received from an image-sensing device component. In such embodiments, the method may include the step of, in response to determining that a change between successive images captured by the image-sensing device is greater than a threshold value, performing the aforementioned steps of emitting a signal towards the scene, detecting the intensity of a signal that has been reflected by the scene, and determining at least one depth measurement. In cases where a change in the scene is detected, the method may comprise determining a portion of the captured scene in which the change is detected. In such embodiments, one of a plurality of emitters may be controlled in dependence on the portion of the scene in which the change is detected.

In some embodiments, the ToF depth sensor comprises at least one context sensor. The context sensor may be at least one of: an accelerometer, an image-sensing component, and a location sensing component. In some embodiments, the method comprises receiving a signal from the context sensor and adjusting at least one of the intensity and frequency of the signal output by the emitter in dependence upon the signal received from the context sensor. Where the context sensor is an accelerometer, the method may include controlling the emitter to increase the modulation frequency in response to a detection of movement by the accelerometer.

In some implementations, the time-of-flight sensor comprises a single signal sensor having a plurality of detectors, which plurality of detectors are grouped across the surface of the signal sensor into tiles of detectors, wherein the method comprises reading out data from the sensor on a tile-by-tile basis. The method in such implementations may further comprise compressing the readout data from the sensor on a tile-by-tile basis.

The method may also comprise calculating depth values for pixels based on pixel values of a plurality of readouts of the illumination sensor, by obtaining a plurality of tiles of data read out from the same tile of detectors at different times, and calculating the depth values using the obtained plurality of tiles of data.

In a third embodiment there is provided a non-transitory computer readable storage medium comprising instructions that, when executed by a time-of-flight sensor apparatus, cause the time-of-flight sensor apparatus to perform a method comprising: receiving context information about a scene for depth capture by the time-of-flight depth sensor; adjusting, in dependence on the received context information, a modulation frequency or intensity of a signal to be output from at least one emitter; emitting a signal towards the scene using the at least one emitter with the adjusted intensity or modulation frequency of output signal; detecting, using at least one signal sensor, the intensity of signal from the emitter that has been reflected by the scene; and calculating at least one depth measurement based on the measured intensity of the detected signal that has been reflected by the scene.

According to a further embodiment there is provided a signal sensor having a plurality of detectors, which plurality of detectors are grouped across the surface of the sensor into tiles of detectors, wherein the time-of-flight sensor is configured to read-out data from the sensor on a tile-by-tile basis.

The signal sensor may be configured to read-out from the detectors within each tile in row major order. In some embodiments the tiles may be read-out in row major order.

The signal sensor may be an image sensor for a time-of-flight sensor apparatus.

According to a further embodiment, there is provided a method for a signal sensor having a plurality of detectors, which plurality of detectors are grouped across the surface of the sensor into tiles of detectors, the method comprising reading-out data from the sensor on a tile-by-tile basis.

The method may further comprise compressing data read-out from the signal sensor on a tile-by-tile basis.

Particular embodiments will now be described with reference to the Figures.

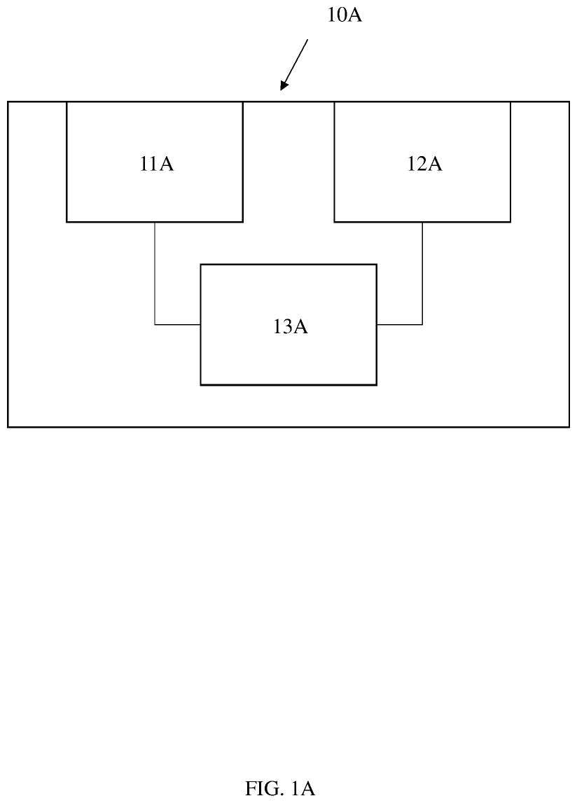

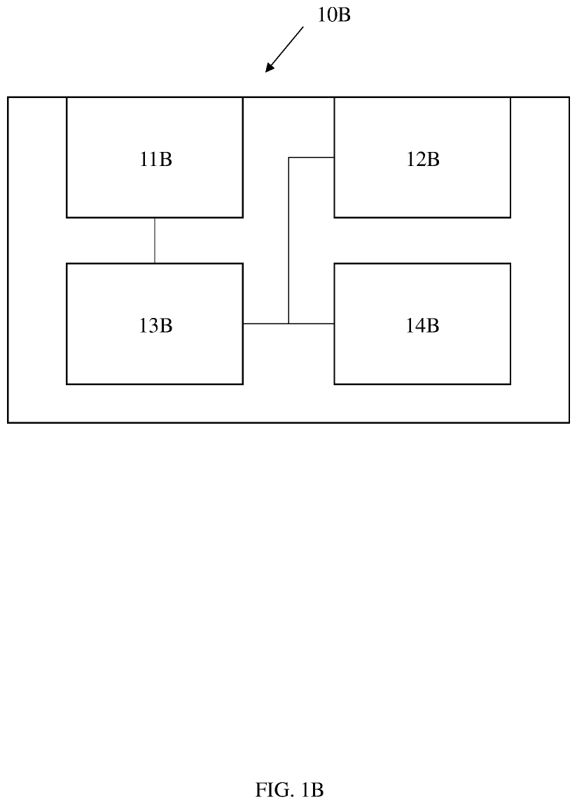

FIG. 1A is a schematic diagram showing hardware of a ToF depth sensor 10A suitable for use on an item of user equipment such as a smartphone, or an Augmented Reality (AR) headset. The system 10A includes an emitter in the form of an illuminator 11A configured to emit light to illuminate a scene, as well as an illumination sensor 12A configured to receive light and detect light reflected from the scene. A controller 13A is provided in the form of a processor and memory. The illuminator 11A is a solid-state laser or LED operating in the near infra-red range (˜850 nm) and the illumination sensor 12A is a sensor designed to respond to the light in the near infra-red range. The illuminator 11A and illumination sensor 12A are connected to the control element 13A, such that the control element 13A can receive information from the illumination sensor 12A and apply controls and adjustments to the illuminator 11A based on this information. It will be appreciated that a depth sensor system may include further components neither shown nor described in FIG. 1A.

A further implementation of a ToF depth sensor is shown in FIG. 1B. Similar to FIG. 1A, FIG. 1B shows a ToF depth sensor 10B, having an illuminator 11B, an illumination sensor 12B and a controller 13B. FIG. 1B further includes a context sensor 14B. The context sensor operates independently from illuminator 11B and illumination sensor 12B and may for example be an image-sensing component or accelerometer. The context sensor 14B is also connected to the control element 13B to enable control element 13B to adjust settings of illuminator 11B based on information from context sensor 14B.

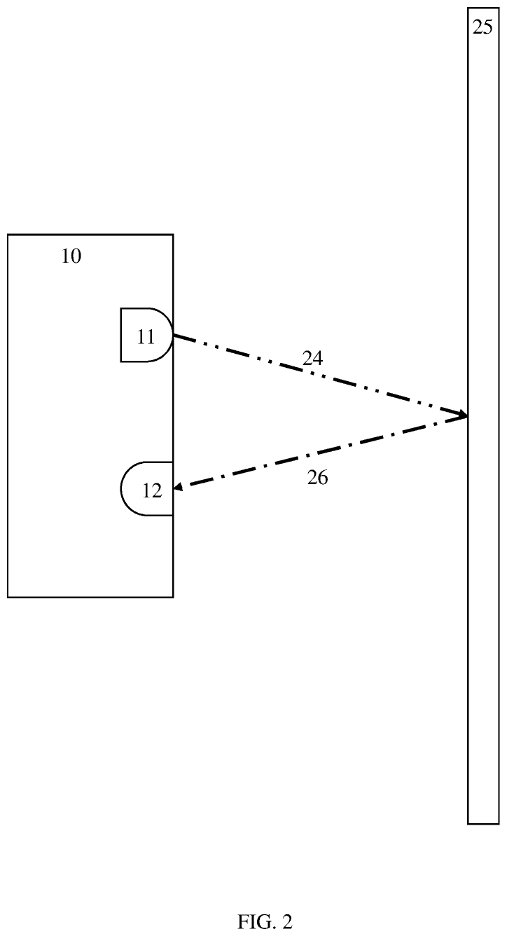

FIG. 2 is a schematic diagram showing the basic operation of a ToF depth sensor 10. The ToF sensor 10 has an illuminator 11 and an illumination sensor 12. Illuminator 11 emits a light beam 24 to illuminate a scene in front of the system 10 An object 25 in the scene is illuminated. Light beam 24 is reflected off object 25 to create a reflected light beam 26. Reflected light beam 26 returns to ToF sensor 10, where it is detected and received by illumination sensor 12.

The illumination sensor 12 is contains an array of photodetectors, such as phototransistors or photodiodes. These photodetectors convert the photonic energy of the reflected light beam 26 into electrical current, allowing the sensor to measure intensity of the reflected light beam 26. The photodetectors accumulate charge during an exposure phase and are periodically read-out, during which read-out process charge is drained from each photodetector and measured.

The illumination sensor 12 measures charge from each photodetector. These measured amounts of the electrical current correspond to the photonic energy of the reflected light beam 26 during the exposure time corresponding to the measurement taken.

The illuminator 11 is configured to emit a modulated light beam. The light beam 24 is modulated with a sine or square wave. The modulation is intensity modulation, such that the intensity of the light emitted by the illuminator 11 varies over time.

The ToF sensor 10 receives reflected light beam 26 and, using the illumination sensor 12, samples the modulated light at four separate points in each complete cycle of the modulated emitted beam 24. Each sample point is 90 degrees removed from the point before, so the four samples are evenly spaced throughout the timing cycle of the emitted light beam 24. One example of evenly spaced sample points would be samples taken at 90, 180, 270 and 360 degrees. The values of each sample may be designated Q₁ through Q₄, with each Q-value representing a separate sample.

Using the sample values Q₁ through Q₄, the phase shift between emitted light beam 24 and reflected light beam 26, φ, may be calculated as follows:

$$φ = arctan \frac{{Q}_{3} - {Q}_{4}}{{Q}_{1} - {Q}_{2}}$$

The phase shift φ is then used to calculate the distance d between system 10 and object 25, as follows:

$$d = \frac{c}{4 π f} φ$$

where c is the speed-of-light constant and f is the modulation frequency of the emitted light beam 24.

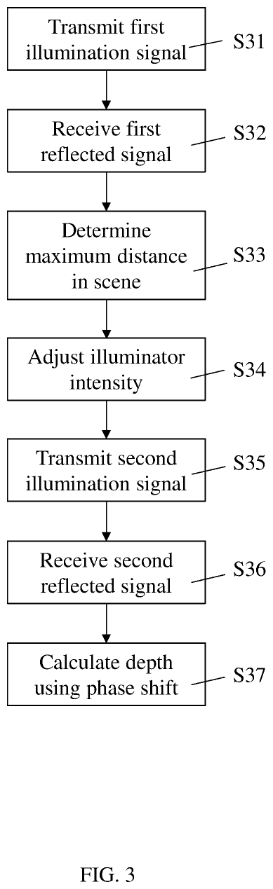

FIG. 3 is a flow chart showing steps of a method for measuring depth using a ToF depth sensor 10. Using the ToF depth sensor 10A described in connection with FIG. 1, the ToF depth sensor 10A collects context information about a scene for depth capture and uses the context information to adjust illumination parameters. FIG. 3 shows an example of this process in which the context information is depth information detected by the illumination sensor 12A.

In step S31, the depth sensor system emits a first light beam. As shown in FIG. 2 and described above, this light is emitted by an illuminator 11 within the ToF depth sensor 10A. The first light beam illuminates the scene in front of the system for depth capture, and reflects off objects within the scene, creating a first reflected light beam 26. In step S32, the first reflected light beam is received by the ToF depth sensor 10A, using the illumination sensor element 12 previously described. In step S33, the first reflected light beam is measured several times and these measurements are used to calculate distance within the scene. As described in connection with FIG. 2, this is accomplished by calculating the phase shift of the first reflected light beam, and from this value determining a distance measurement. The depth calculation is performed multiple times for pixel values read out from across the illumination sensor. The ToF depth sensor 10A determines, from the pixel measurements made from across the illumination sensor element 12, the maximum distance present in the scene presented for depth capture. This maximum distance measurement forms context information for this embodiment.

In step S34, the ToF depth sensor 10A adjusts the peak intensity of light emitted by the illuminator 11 in dependence on the maximum distance measurement determined in step S33. This may be done by comparison with a threshold. For example, if the maximum distance within the scene is under five (5) meters, the ToF depth sensor 10A may reduce the peak intensity of the modulated light to 50%. This reduction of illuminator intensity in close-range applications—where greater intensities are unnecessary—allows for a reduction in power consumption by the ToF sensor 10A without compromising accuracy. Any practical scheme for adjusting illuminator intensity in dependence on context information may be used. Such methods may for example include use of multiple thresholds, where illuminator intensity is reduced to a given percentage unless a particular threshold maximum distance is present in the depth measurements

In step S35, the ToF depth sensor 10A emits a second light beam. This second light beam is modulated with an intensity that was set in step S34. In the example provided above, the second light beam is emitted at 50% intensity. As described for steps S31 and S32, and in FIG. 2, this second light beam is emitted by the illuminator 11, illuminates the scene presented for depth capture, and is reflected off an object 25 within the scene creating a second reflected light beam 26. In step S36, this second reflected light beam is received by the ToF depth sensor 10A through the illumination sensor 12.

In step S37, the ToF depth sensor 10A uses the second reflected light beam received in step S36, along with the second light beam generated in step S35, to calculate the phase shift φ of the second reflected light beam. This phase shift is then used to calculate the distance d between the ToF depth sensor 10A and the object within the scene, as described in relation to FIG. 2.

The above example describes controlling peak intensity of the modulated light emitted by the illuminator 11 in response to the maximum distance measurement. It is noted here that the frequency of the light (e.g. infrared light) is not varied, but that the light is intensity modulated so that the frequency/wavelength can be controlled. In other implementations, the modulation frequency may be varied in dependence upon the determined maximum distance measurement. This can be done in order to preserve accuracy of readings. When the maximum distance in the scene presented is such that a full period of the light beam generated elapses before the light beam is reflected, the system may be unable to accurately calculate the depth of the scene. Reducing the modulation frequency will alleviate this, as the period of the light beam will be longer, meaning that greater depths can be accurately measured.

A higher modulation frequency (shorter modulation wavelength) allows for more accurate distance measurements, but at the expense of more frequent sampling and a greater number of calculations to be performed. Inversely, using a lower frequency (longer modulation wavelength) reduces the number of samples per unit time and reduces overall processing, but at the expense of less frequent measurements. Accordingly, in cases where the measured maximum distance is longer, the modulation frequency may be reduced because measurement accuracy at larger distances will be reduced in any case. The reduction in modulation frequency may be done in combination with increasing the peak modulation intensity in order to maintain intensity of the measured reflected light beam 26 when the light travels a further distance.

In further embodiments, other context information may be used in addition to the maximum distance. In some embodiments, the context information may comprise information regarding the reflectivity of objects in the scene, which may be determined by comparing the intensity of the received reflected light to the light intensity emitted from the illuminator 11. If the intensity of the received reflected light is low for a particular distance of object (the object has a low reflectivity), the intensity of light emitted by the illuminator may be increased.

In other embodiments, the context information may comprise information about the background noise of the scene, which may be determined by analyzing the signal-to-noise ratio of the received light. The light received by the illumination sensor 12 will include background light from the scene in addition to the light emitted from the illuminator 11. It is desirable that the received intensity of the background light is not too large relative to the intensity of the reflected light from the illuminator 11. If the intensity of the background light is large (a low signal to noise ratio), the illuminator 11 may be controlled to increase the intensity of emitted light. Such embodiments may be useful for applications of the ToF depth sensor system in outdoor environments in which the levels of background light are likely to be higher.

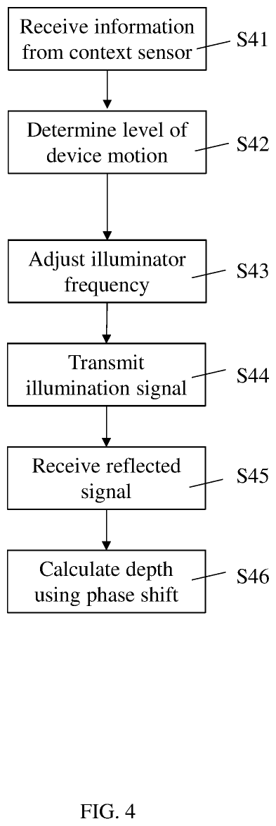

FIG. 4 is a flow chart showing steps of a method of a ToF depth sensor 10B of the type described in connection with FIG. 1B. In contrast to the example described in connection with FIG. 3, in which the context information was a maximum distance detected within the scene, in the example shown in FIG. 4 the context information comprises information regarding whether the device in which the ToF depth sensor 10B is situated is static or in motion.

In step S41, the ToF depth sensor 10B receives information from a context sensor 14B. The context sensor 14B is an accelerometer, and the context information received from the context sensor is information regarding device motion. In step S42, motion of the device is determined based on a signal from the accelerometer.

In step S43, the ToF depth sensor 10B adjusts the modulation frequency of the light to be emitted by the illuminator 11 in dependence on the context information determined in step S42. The adjustment of the modulation frequency may be performed by comparison with a threshold value. For example, if the device determined to be moving at 5 m/s based on measurements from the accelerometer, the modulation frequency may be increased to 100% of the maximum frequency because as explained above, the sampling frequency is determined by the modulation frequency and a higher modulation frequency therefore allows more frequent measurements. This is only one example, and any practical scale or means of relating modulation frequency of light emitted by the illuminator 11 to device movement may be used.

From step S44 onward, the method is very similar to that described in relation to FIG. 3. In step S44, the ToF depth sensor 10B emits, from the illuminator 11, a light beam. This light beam is emitted at a modulation frequency as adjusted in step S43. In the example provided, the light beam is emitted at the maximum frequency supported by the ToF sensor 10B. This light beam illuminates the scene presented for depth capture and is reflected off an object 25 within the scene, creating a reflected light beam. In step S45, the reflected light beam is received by the illumination sensor 12 of the ToF depth sensor 10B. This reflected light beam is then, along with the light beam emitted in step S44, used to calculate phase shift φ of the reflected light beam—phase shift φ is used in turn to calculate distance d between the ToF depth sensor system and the object.

Some embodiments utilizing multiple illuminators will now be described. As described, in some implementations a single illuminator 11 is used causing the entire scene presented for depth capture to be illuminated with the same intensity and modulation frequency, potentially wasting power. For example, a scene mostly containing objects within five meters of the sensor, but with one quadrant of the scene only having objects fifteen meters away would, with a single illuminator 11, be lit in its entirety at the higher intensity demanded by the greater distance. Accordingly, some embodiments that will now be described include multiple illuminators, each configured to have adjustable intensity and frequency of the modulated light signal emitted, which allow power consumption to be improved. In these embodiments, each illuminator 11 may have illumination parameters configured separately to optimize the balance between power and accuracy.

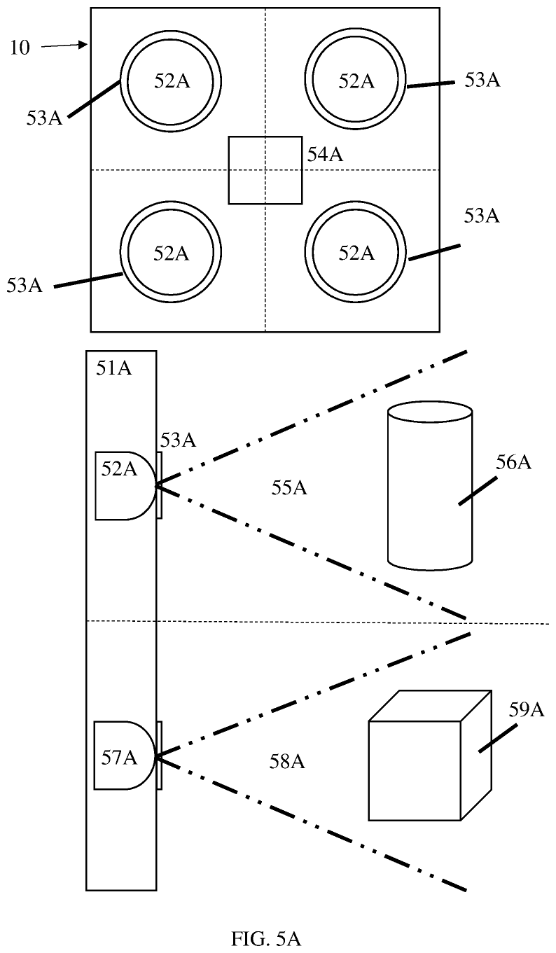

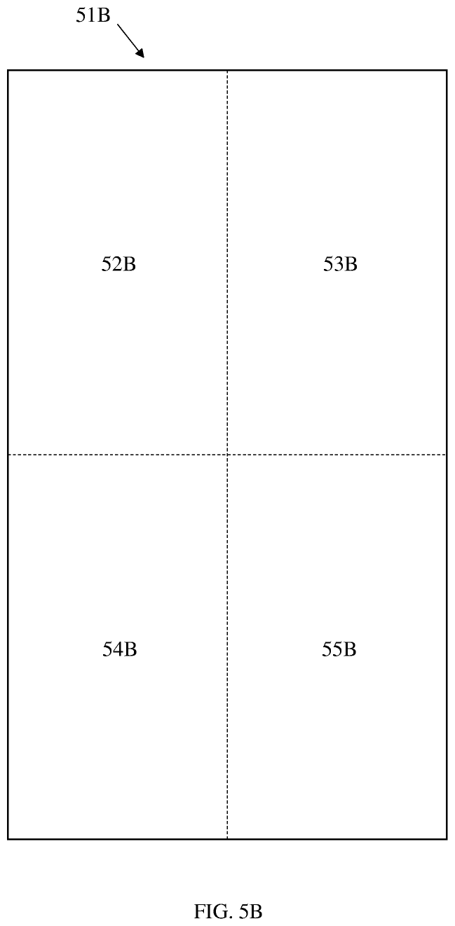

FIG. 5A is a diagram showing an arrangement of illuminators of a ToF system. The ToF depth sensor 10 has multiple illuminators 52A, each illuminator positioned in a separate quadrant. Each illuminator 52A has adjustable intensity and frequency and is provided with a lens 53A. Lens 53A diffuses the light beam emitted by illuminator 52A so that a wider area of the scene presented for depth capture is illuminated. The lens 53A also serves to direct light to a particular quadrant of the scene. The ToF depth sensor 10 further includes an illumination sensor 54A, as described previously.

Each illuminator 51A is positioned to selectively illuminate a particular portion of the scene. In the example shown, each illuminator is positioned to selectively illuminate one quadrant of the scene presented. The lower half of FIG. 5A shows a simplified plan view of such a system 51A illuminating a scene. The light beam 55A is emitted by illuminator 52A, passing through lens 53A and spreading out in a cone pattern. The light beam 55A illuminates one part of the scene presented, including object 56A. Simultaneously, second illuminator 57A emits a second light beam 58A, which passes through a similar lens and illuminates a second part of the scene presented, including object 59A. The light beams 55A and 58A emitted by illuminators 52A and 57A respectively may have identical peak modulation intensity and modulation frequency, or may have different values for these parameters. In this manner, the separate illuminators selectively illuminate separate portions of the scene presented for depth capture.

FIG. 5B shows the effect that the arrangement of illuminators 52A described above would have on the illumination of a scene presented for depth capture. In FIG. 5B, scene 51B is presented to a ToF sensor 10 as described above, for depth capture. Scene 51B is illuminated by multiple illuminators arranged and configured as described. The effect is that each quadrant of scene 51B, marked as 52B, 53B, 54B and 55B, is illuminated by a single illuminator. As such, each of these quadrants may be illuminated at a different intensity or frequency to every other quadrant.

The arrangement of illuminators presented above is only one embodiment of the invention. Other embodiments may have different numbers of illuminators in different arrangements. One such embodiment may have an illuminator configured to illuminate an upper third of the scene presented for depth capture, an illuminator configured to illuminate a lower third of the same scene, and multiple illuminator configured to illuminate separate areas of a middle third.

In further embodiments, a single illuminator may be used in combination with a plurality of mirrors, which are used to direct the light to different parts of the scene. For example, a micro-mirror array could be used to selectively direct light to different parts of the scene. Such embodiments may allow energy waste due to illuminating unnecessary parts of the scene for which depth measurements are not required to be reduced.

There may be overlap regions of the quadrants 51B that are illuminated by more than one illuminator 52A. Such regions could be ignored in the depth measurement processing or the additional illumination may be taken into account the processing of the measured reflected light.

The embodiments described above control the peak modulation intensity and the modulation frequency in dependence upon the context information received. The modulation frequency selected is a tradeoff between power consumption and accuracy. A higher modulation frequency necessitates more frequent measurements by the illumination sensor and more power consumed performing depth calculations but provides more accurate distance measurements because the wavelength of the square or sinewave is shorter. In some embodiments, depth measurements may be performed at a first modulation frequency by the ToF depth sensor 10 and then periodically the ToF depth sensor 10 may perform measurements with a higher modulation frequency. Such a scheme may be useful for saving power in applications in which the scene is not expected to vary by much. The lower modulation frequency measurements may be used to confirm that the scene hasn't changed, and the higher modulation frequency measurements may be used to provide a more accurate measurement.

In other implementations, the ToF sensor 10 may by default make measurements using the first lower modulation frequency mentioned above and only make a measurement at the higher second modulation frequency if a predetermined difference is determined between infrared images measured by the illumination sensor at the first lower modulation frequency.

In a yet further implementation, the second context sensor 14B may be a video camera and a depth measurement at the higher second modulation frequency may be triggered by a detection of motion in the video camera feed.

In implementations in which multiple illuminators 52A, such as the four illuminators shown in FIG. 5A, are used, not all illuminators need to be used at any one time. For example, the schemes described in the preceding paragraphs may be applied on a quadrant-by-quadrant basis. In some further embodiments, the ToF sensor 10 may be configured to perform motion detection on images captured by the illumination sensor 12, by an RGB sensor, or by another camera. This motion detection may comprise comparing the different results from the sensor or camera from frame-to-frame, and adjusting the illumination and processing rate in dependence on the level of change between frames. In such embodiments, the frequency light emitted by the illuminator for each quadrant may be controlled depending on whether or not motion is detected within that quadrant of the scene. If motion is detected within a quadrant of the scene, the corresponding illuminator may be controlled by the controller 13 to emit light at a higher modulation frequency than in the case that no motion is detected.

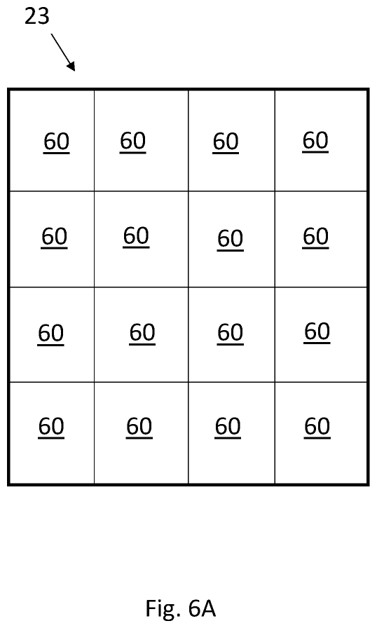

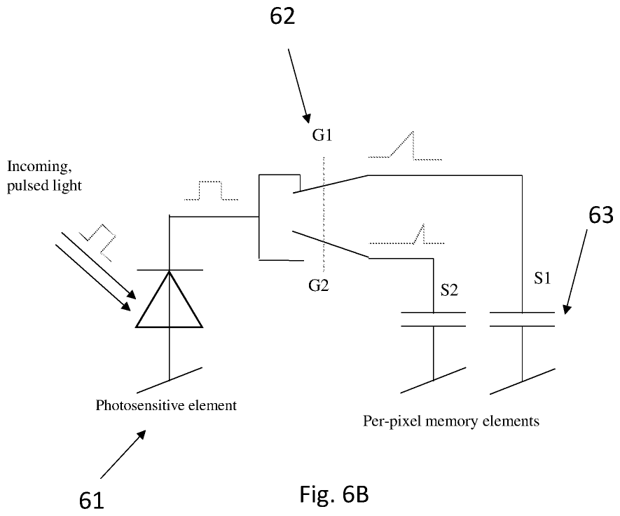

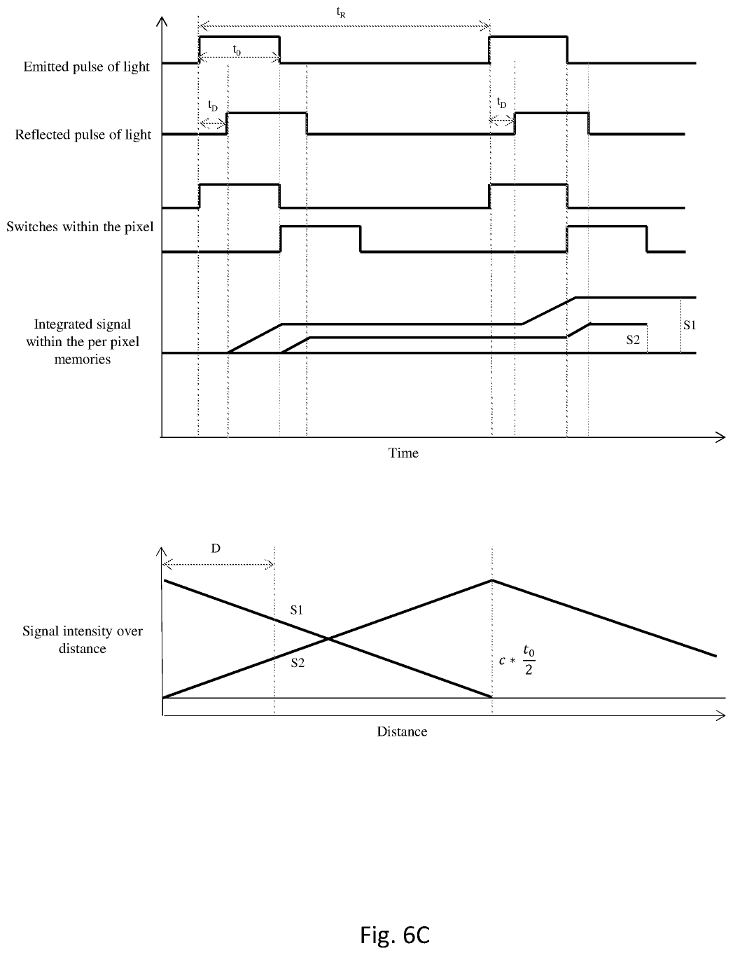

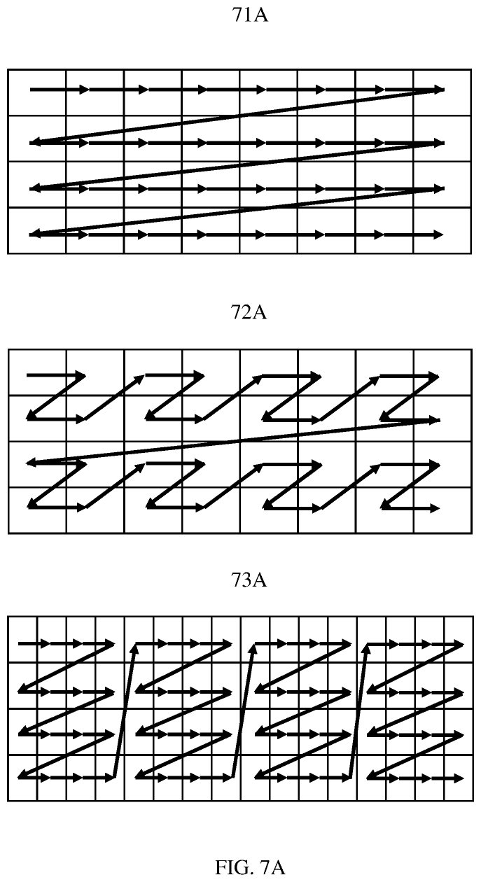

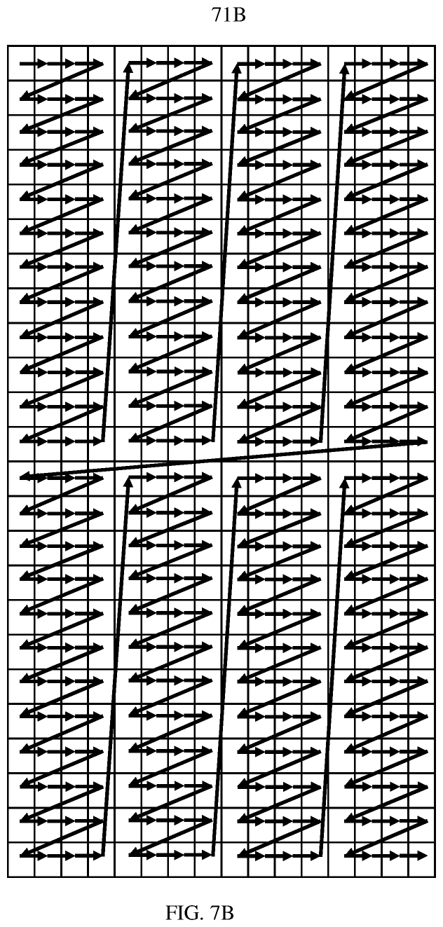

FIG. 6A is a schematic diagram showing a tile-based illumination sensor 12. The sensor includes an array of photodetector elements. For example, the sensor may be an array of 320 by 240 photodetector elements. Each photodetector element includes a circuit as shown in FIG. 6B. The photodetector elements are grouped into tiles of photodetector elements 60, each tile being formed of a group of 80 by 60 photodetector elements. The illumination sensor 12 is designed to read out the photodetector elements on a tile-by-tile basis as will be described in connection with FIGS. 7A and 7B.

Referring to FIG. 6B, the circuit for a photodetector comprises a photosensitive element 61, a pair of gates G1 and G2 labelled 62 and a pair of capacitors S1 and S2, labelled 63. The circuit diagram shows a photodetector receiving a square wave infrared light signal, which is generated by a laser illuminator modulated by a 1 or 0 signal. Gates G1 and G2 are controlled with a timing that is the same length as the emitted light pulse emitted by the illuminator, whereby the control signal of gate G2 is delayed by exactly the pulse width. This is illustrated in the third and fourth lines of FIG. 6C, labelled as “switches within the pixel”.

Light from the incoming light pulse strikes the photosensitive element 61 and is converted into current, which travels through the gates G1 and G2. Depending on the delay of the reflected light, each gate will receive a different proportion of the current for each pulse. The current is directed through the relevant gate G1 or G2 and passed to respective capacitor S1 or S2. The capacitors S1 and S2 act as summation elements, storing the electrons collected by the photosensitive element 61 and passed through the relevant gate G1 or G2. The voltage in each capacitor S1 or S2 at the end of the integration period is the signal produced by the photodetector and is used to calculate phase delay.

FIG. 6C is a timing diagram showing timings of the photodetector shown in FIG. 6B. The top of the diagram shows timings of light emission by the illuminator 11. Square light pulses are emitted by the illuminator 11 every t_{R} seconds. The second line shows timings of light received at the illumination sensor 12. It can be seen that the received light is formed of reflected square wave light pulses received with a time delay corresponding to the time taken for the light to travel to an object, be reflected and return to the illumination sensor 12. Accordingly, these square wave light pulses are off-set (out of phase) with the emitted light pulses.

The switches (gates G1 and G2 above) are operated such that a first reading of the photosensitive element occurs at the same time that a light pulse is emitted and a second reading of the photosensitive element is made during a time period adjacent and following the time period during which the pulse of light is emitted. These two time periods can be seen on the third and fourth lines of FIG. 6C respectively. In the example shown in the figures, the light will be received from the reflected light pulse in both the first and second reading periods controlled by the gates G1 and G2 respectively. The bottom line in the timing diagram of FIG. 6C shows integrated charge accumulation in the capacitors S1 and S2 over a time of two emitted and received light pulses.

The bottom part of FIG. 6C explains how to calculate a distance measurement based on the measured values S1 and S2. It can be understood that if all of the emitted pulse arrives at the photodetector 61 during a period exactly one pulse length's time later (a time to later) no light would be received in the first capacitor S1 and all the light would be received in the measurement window of the second capacitor. This is shown on the signal intensity over distance graph at the point where S1=0 and S2 is maximum. Here the light has travelled c*t₀ distance, where c is the speed of light and the object that the light is reflected from is a distance c*t₀/2 away, because the light performs a round trip. For other measured ratios of S1 and S2 it is possible to determine a measured distance by a simple linear calculation illustrated by the graph in FIG. 6C.

The above example is simplified and a ToF sensor 10 would typically look at four or eight time periods to determine the phase of the reflected pulse of light. The circuit shown in FIG. 6B may therefore be adapted to have four or eight capacitors.

The method described above in connection with FIGS. 6B and 6C is efficient because the capacitors can be read out and the data directly processed in an energy efficient manner avoiding the need for frame buffers.

As mentioned in connection with FIG. 6A, the illumination sensor 12 is formed of tiles of photodetectors and the tiles are read out on a tile-by-tile basis. In FIG. 7A, several possible readout orders are shown. In these figures each square represents a single photodetector. The sensor will, in general, include a large number of photodetectors, but a smaller number are shown in FIGS. 6A and 6B for illustrative convenience.

71A shows a conventional raster readout of the type commonly found in the prior art, wherein each line of photodetectors is read out sequentially. Processing measurements from multiple lines of photodetectors often requires storing these lines of data on local memory. Examples which follow make use of a tiled readout that allows data from the sensor to be processed in tiles. Processing the data in tiles allows memory and processing efficiencies that can lower power consumption.

72A and 73A of FIG. 7A show examples of tile-based readout orders from an illumination sensor. 72A shows a tiled readout pattern that reads out in a 2×2 tile. Each 2×2 tile is read out in row major order. The tiles are also read out in row major order across the sensor. As will be explained below, the depth calculations can be performed on a tile-by-tile basis. Accordingly, the need for delay lines to account for differences in time of read-out across the entire image sensor can be mitigated or eliminated by using this readout pattern.

FIG. 73A shows a second possible readout pattern. In this pattern, the photodetectors are read out in a 4×4 tile pattern. As with pattern 72A, each tile is read out in row major order and the tiles are read out in row major order across the illumination sensor 12. This pattern may be particularly well suited for use with quasi-lossless compression algorithms. The embodiment may use a lossless compression scheme such as AFBC (ARM Frame Buffer Conversion), or may use lossy compression schemes.

FIG. 7B shows, in 71B, a striped-tiled readout, which reads out 4×16 tiles. As before the photodetectors within a tile are read out in row major order and the tiles are readout in row major order across the illumination sensor 12. This readout scheme may be particularly suitable for image processing algorithms that require larger pixel neighborhoods, such as spatial noise reduction or local motion estimation.

The use of tile-based illumination sensors within a ToF sensor 10 allows for tile-by-tile processing by the ToF depth sensor. As noted above, a first feature of such tile-based image sensors is that the use of delay lines may be reduced because when processing on a tile-by-tile basis it is only necessary to be concerned about time delay of read-out within the tile rather than across the whole sensor when performing a conventional full image sensor raster scan.

A second feature of tiled readout patterns is the ability to improve compression of the readout data for data storage and retrieval within the ToF sensor 10. Several tile-based image compression algorithms are known, such as AFBC (ARM Frame Buffer Compression) and other compression algorithms including lossy compression algorithms. A reason for compressing on a tile-by-tile basis is that there is likely to be greater spatial correlation between measured values within a 2D region, for example a tile, due to greater spatial locality between the photodetectors within a tile compared to a conventional raster scan. This tends to lead to better compression performance.

The use of a tiled readout pattern may also improve image processing and reduce resource requirements such as buffers. Image processing is likely to be performed on a 2D region of data. When performing such image processing using image data stored in a conventional raster scan format, multiple lines of data will need to be read out and buffered. In contrast, using a tile format significantly reduces buffering requirements and allows specific selected tiles to be processed separately from the rest of the image, preventing wasted processing power. For example, when independently illuminating quadrants of the scene as described previously, the quadrants of the scene may be selectively retrieved from memory and processed. Furthermore, denoising and filtering operations may be performed more readily on tiles of data than on lines of data. More specifically for the ToF sensor 10, the depth calculations may be performed on a tile-by-tile basis allowing depth calculations to be performed selectively for selected parts of a scene being captured by the illumination sensor 12. As explained above, multiple images from different times are required to determine the phase shift and perform a distance calculation. If this calculation is performed on a tile-by-tile basis it is possible to retrieve data only for the selected tile, thereby reducing memory requirements when performing the calculations and avoiding the need to retrieve, for example, four complete image sensor read outs to perform a calculation.

Embodiments described above use a single sensor and perform a tile-based readout from that sensor before processing the read-out data in tiles. However, in other implementations, multiple image sensors could be arrayed and each image sensor in the array could be readout and processed sensor-by-sensor in a similar manner to the tile-by-tile processing described above.

The ToF depth sensors described above have been sensors that use a phase shift in the returned light relative to the emitted light to calculate distance. The teaching above may be applied to other types of depth sensor, such as direct time-of-flight sensors which directly measure the time of flight of a laser pulse that leaves the sensor and reflects back to the sensor. Such direct time-of-flight sensors may not have a modulation frequency of the emitted light, but the intensity of the emitted light may be varied in accordance with the techniques described above.

Embodiments have been described above in which the frequency of measurements by the illumination sensor is controlled to correspond to the modulation frequency of the light emitted by the illuminator. In some further embodiments an illuminator may illuminate a scene and a plurality of illumination sensors or portions of an illumination sensor may be controlled to measure distance with differing measurement frequencies for different parts of the scene. For example, if motion is detected in a particular quadrant of a scene, a portion of an illumination sensor corresponding to that quadrant may read out measurements or calculate depth values for that quadrant at a higher frequency than read out measurements or calculation of depth information for the other quadrants. For example, the higher frequency may correspond to a depth measurement performed at the same frequency as the modulation frequency of light emitted by the illuminator, whereas the lower frequency, associated with the portions of the illumination sensor recording light from other quadrants, may correspond to a readout or calculation every other cycle of the modulation frequency of the emitted light.

Further, although light-based ToF depth sensors have been described above, other embodiments may make use of, for example, an ultrasound emitter and receiver to measure the distance.

Various time-of-flight sensors have been described above. The time-of-flight sensors may be included in various hardware including, but not limited to, extended reality headsets, mobile phones, vehicle sensors, robotics and surveillance cameras. In cases where processing to map the surrounding environment is desired, depth information from the time-of-flight sensors may be used with software, such as simultaneous location and mapping (SLAM), to form a map and keep track of location within that map.

The methods described herein may be embodied in software, wholly in hardware or in any combination thereof. Where a software implementation is used, examples may comprise a computer-readable medium, which may be a non-transitory computer-readable medium, comprising computer-executable instructions that, when executed by a processor instruct the processor to carry out the method.

What is claimed is:

1. A time-of-flight (ToF) depth sensor apparatus, comprising
an emitter configured to emit a signal towards a scene, which emitter is controllable to adjust at least one of an intensity and a modulation frequency of the signal output from the emitter;
at least one signal sensor, configured to detect an intensity of the signal from the emitter that has been reflected by the scene; and
a controller configured to receive context information about the scene for depth capture by the time-of-flight depth sensor and to adjust at least one of the intensity and modulation frequency of a signal output by the emitter in dependence on the context information.

2. An apparatus according to claim 1, wherein the emitter comprises a single emission source.

3. An apparatus according to claim 1, wherein the emitter comprises a plurality of emission sources, wherein the controller is configured to control at least one of the intensity and modulation frequency of each emission source separately.

4. An apparatus according to claim 3, wherein the emission sources are configured to direct signals to different portions of the scene.

5. An apparatus according to claim 1, wherein the emitter comprises a single emission source and a plurality of reflective elements arranged to direct the signal to different portions of the scene.

6. An apparatus according to claim 1, further comprising at least one context sensor, wherein the at least one context sensor comprises at least one of: an accelerometer, an image-sensing component, and a location-sensing component, and wherein the controller is configured to receive a signal from the context sensor and to adjust at least one of the intensity and frequency of light output by the emitter in dependence upon the signal received from the context sensor.

7. An apparatus according to claim 6, wherein the context sensor is an accelerometer and the controller is configured to control the emitter to increase the modulation frequency in response to a detection of movement by the accelerometer.

8. An apparatus according to claim 1, wherein the context sensor is an image-sensing component and the controller is configured to increase the modulation frequency in response to a detection of movement in the scene.

9. An apparatus according to claim 1, wherein the at least one signal sensor comprises a plurality of signal sensors configured to detect signals from the emitter that have been reflected by the scene.

10. An apparatus according to claim 1, wherein the time-of-flight sensor apparatus comprises a single signal sensor having a plurality of detectors, which plurality of detectors are grouped across the surface of the sensor into tiles of detectors, wherein the time-of-flight sensor is configured to read out data from the sensor on a tile-by-tile basis.

11. An apparatus according to claim 10, wherein the time-of-flight sensor apparatus is configured to compress pixel values read out from the sensor on a tile-by-tile basis.

12. An apparatus according to claim 11, wherein the time-of-flight sensor apparatus is configured to calculate depth values based on a plurality of readouts from the signal sensor, each readout occurring at a different time, wherein the calculation of depth values is performed on a tile-by-tile basis.

13. A method for measuring depth using a Time-of-Flight (ToF) depth sensor, the method comprising:
receiving context information about a scene for depth capture by the time-of-flight depth sensor;
adjusting, in dependence on the received context information, a modulation frequency or intensity of a signal to be output from at least one emitter;
emitting a signal towards the scene using the at least one emitter with the adjusted intensity or modulation frequency of output signal;
detecting, using at least one signal sensor, the intensity of light from the emitter that has been reflected by the scene; and
calculating at least one depth measurement based on the measured intensity of the detected signal that has been reflected by the scene.

14. A method according to claim 13, wherein the context information comprises information regarding content of the scene received from an image-sensing component and comprising the step of, in response to determining that a change between successive images captured by the image-sensing device is greater than a threshold value, performing the steps of emitting a signal towards the scene, detecting the intensity of signal that has been reflected by the scene, and determining at least one depth measurement.

15. A method according to claim 14 wherein the time-of-flight sensor comprises a single signal sensor having a plurality of detectors, which plurality of detectors are grouped across the surface of the signal sensor into tiles of detectors, wherein the method comprises reading out data from the sensor on a tile-by-tile basis.

16. A method according to claim 15, further comprising compressing the readout data from the sensor on a tile-by-tile basis.

17. A method according to claim 16, further comprising calculating depth values for pixels based on pixel values of a plurality of readouts of the signal sensor, wherein the method comprises: obtaining a plurality of tiles of data read out from the same tile of detectors at different times, and calculating the depth values using the obtained plurality of tiles of data.

18. A non-transitory computer readable storage medium comprising instructions that, when executed by a time-of-flight sensor apparatus, cause the time-of-flight sensor apparatus to perform a method comprising:
receiving context information about a scene for depth capture by the time-of-flight depth sensor;
adjusting, in dependence on the received context information, a modulation frequency or intensity of a signal to be output from at least one emitter;
emitting a signal towards the scene using the at least one emitter with the adjusted intensity or modulation frequency of output signal;
detecting, using at least one signal sensor, the intensity of signal from the emitter that has been reflected by the scene; and
calculating at least one depth measurement based on the measured intensity of the detected signal that has been reflected by the scene.
